(19) United States
(12) Patent Application Publication
(10) Pub. No.: US 2023/0056233 A1
(43) Pub. Date: Feb. 23, 2023

(54) SENSOR ATTACK SIMULATION SYSTEM

(71) Applicant: Motional AD LLC, Boston, MA (US)

(72) Inventors: Benjamin Andrew Cyr, Ann Arbor, MI (US); Michael Alan Maass, Mt. Lebanon, PA (US); Richard Fuchs, Wexford, PA (US)

(21) Appl. No.: 17/408,270

(22) Filed: Aug. 20, 2021

(51) Int. Cl. H04L 29/06

(52) U.S. Cl. CPC H04L 63/1433; H04L 63/1416; H04L 63/1425; H04L 63/1466

(57) ABSTRACT

Provided are methods for sensor attack simulation systems, which can include a processor performing operations comprising receiving a dataset representative of data received from a plurality of sensors at an autonomous vehicle sensor system that measure environmental conditions related to an environment of an autonomous vehicle. The system operations also perform a simulated attack on the dataset. The simulated attack includes at least one of modifying the dataset to imitate a cyberattack and modifying the dataset to imitate a cyber-physical attack in which the cyber-physical attack misrepresents the environmental condition related to the environment of the autonomous vehicle to be measured by the plurality of sensors. The system operations also provide a second dataset based on the simulated attack on the dataset for testing planned movements of the autonomous vehicle.

### BACKGROUND

An autonomous vehicle is a vehicle that is capable of sensing its environment and navigating without human input. Autonomous vehicles rely on multiple types of sensors to perceive the surrounding environment. The sensors provide the autonomous vehicle with data representative of the surrounding environment. The autonomous vehicle performs various processing techniques on the data to make safe and correct movement decisions. These decisions safely navigate the autonomous vehicle to choose a path to avoid obstacles and react to a variety of different driving scenarios, such as the abrupt movements of proximate vehicles.

Testing decisions of autonomous vehicles is generally dangerous and unfeasible in real-world driving environments. Moreover, conventional simulators typically do not model autonomous vehicle decisions based on compromised sensors or a software attack on the autonomous vehicle.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a simulation dataflow;

FIG. 4C is a diagram of an implementation of a simulation dataflow with a sensor attack simulation;

FIG. 5 is a diagram of a sensor attack simulation process for a sensor attack simulation; and

FIG. 6A is a diagram of a safety risk threshold process for determining whether a safety risk threshold is satisfied;

FIG. 6B is a table of safety risk thresholds that correspond to an impact level; and

FIG. 7 is a flowchart of a process for a sensor attack simulation system.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement simulating attacks on an autonomous vehicle in order to assess how the vehicle's systems would respond to such attacks if encountered in a real-world scenario. As an example technique, a simulation system receives a simulated sensor dataset representative of sensors of an autonomous vehicle's sensor system. For example, the sensors of the simulated sensor dataset measure an environmental condition related to an environment of the autonomous vehicle. A simulated attack of the simulated sensor dataset is then performed. The simulated attack can include modifying the simulated sensor dataset and can include misrepresenting an environmental condition related to the environment of the autonomous vehicle that is measured by the plurality of sensors at the autonomous vehicle sensor system. The operation of the autonomous vehicle in response to the attack is then assessed. This technique can be used across many simulated scenarios to determine how the autonomous vehicle's systems would handle such attacks in the real world receiving a simulated sensor dataset from sensors at an autonomous vehicle sensor system.

Unlike other autonomous vehicle motion simulations, the simulation system described herein includes a sensor attack simulation in the simulation data flow. The sensor attack simulation averts dangerous and unfeasible testing in real-world environments. Examples of dangerous testing include attacks on self-driving vehicle prototypes on closed courses. Additionally, the sensor attack simulation may be used to identify high-risk scenarios, security vulnerabilities, and provide feedback to defenses of physical attacks and cyberattacks.

Further, the sensor attack simulation system solves technical problems associated with modeling physical attacks and cyberattacks on the sensor system of an autonomous vehicle. Technical problems may include identifying high-risk cyberattacks on autonomous vehicle sensors. For example, a malicious adversary may attack the autonomous vehicle by hacking the front-right RADAR, shutting off a camera, blocking the camera from detecting a vehicle, and/or any combination thereof. But it may be unclear the extent of the effect that any one of these cyberattacks would have on the autonomous vehicle's ability to continue navigation. Other technical problems include modeling the prediction, planning, and control of the autonomous vehicle in response to cyberattacks on the autonomous vehicle. For example, it is unclear whether the autonomous vehicle software stack can recover from an attack by compensating with other sensors, requiring a combination of sensors to perform emergency maneuvers, and/or how other alterations of the perception or planning stacks influence the behavior of the autonomous vehicle under attack. As such, there is a need for a system to model autonomous vehicle decisions based on compromised sensors and software attacks.

The architecture of the simulation data flow and combination of steps to implement the sensor attack simulation improves on existing simulation implementations. For example, other simulations add noise to the simulation environment or decision-making module. Such simulations are unable to account for a cyberattack blocking the camera from detecting an obstacle and are unable to repeatedly test various combinations of sensor attacks to determine safety implications. In contrast, the architecture of the sensor attack simulation system simulates the attack at the sensor level to provide the most realistic response of the autonomous vehicle planner to the attack. The usefulness of the simulations described herein result in a higher likelihood that the autonomous vehicle stack will perform well when provided with real data in real scenarios. The sensor attack simulation system incorporates as much realism into the simulated environment as possible, including noise and faults.

Factoring in multiple attacks with various combinations of compromised sensors or software to simulate the autonomous vehicle's ability to perform an emergency maneuver improves on existing simulation implementations. For example, unlike other software simulations, the sensor attack simulation system generates a weakened sensor dataset based on a simulated attack. This simulated attack modifies the dataset or models a misrepresentation of the environmental condition related to the surrounding of the vehicle autonomous vehicle. These modifications or misrepresentations may be repeated in a variety of situations and in combination with other sensors to rapidly understand security implications and to serve as feedback to develop new defenses for these attacks. As such, the sensor attack simulation can rapidly determine responses to various combinations of failed or compromised software or sensors.

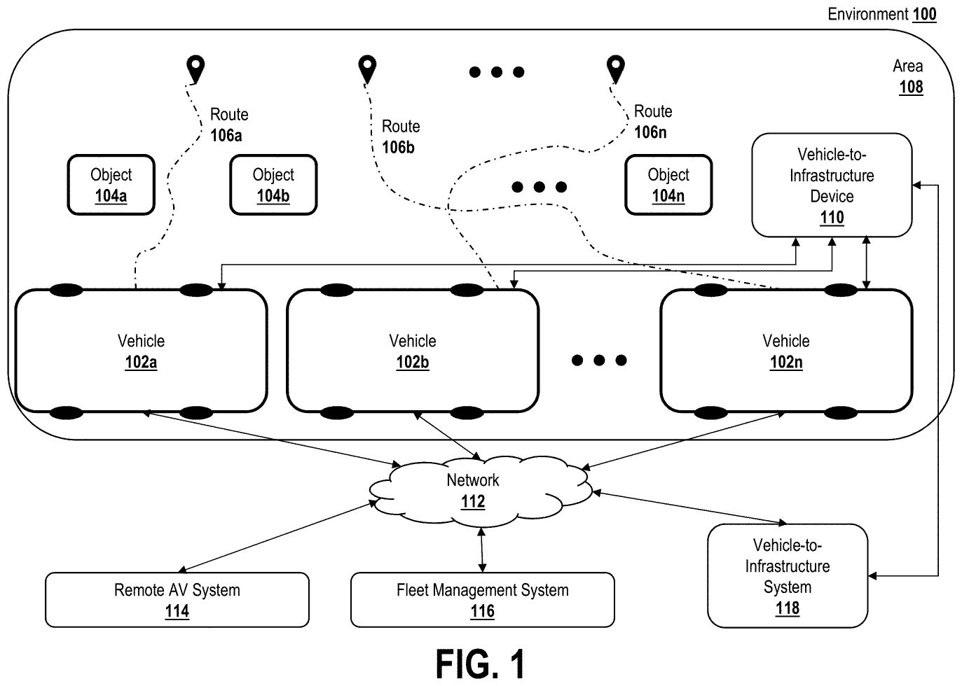

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

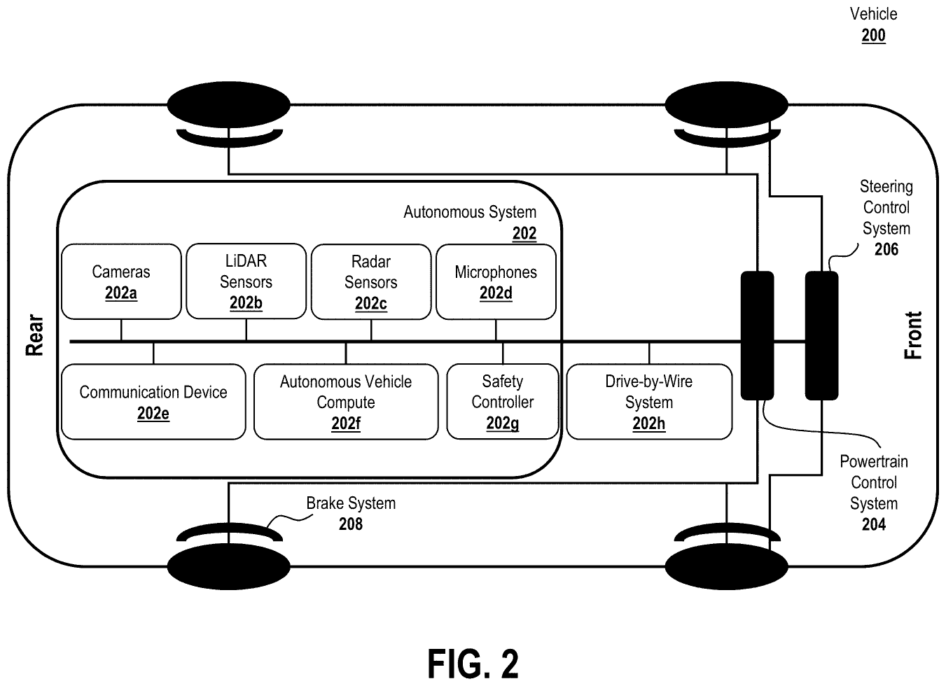

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

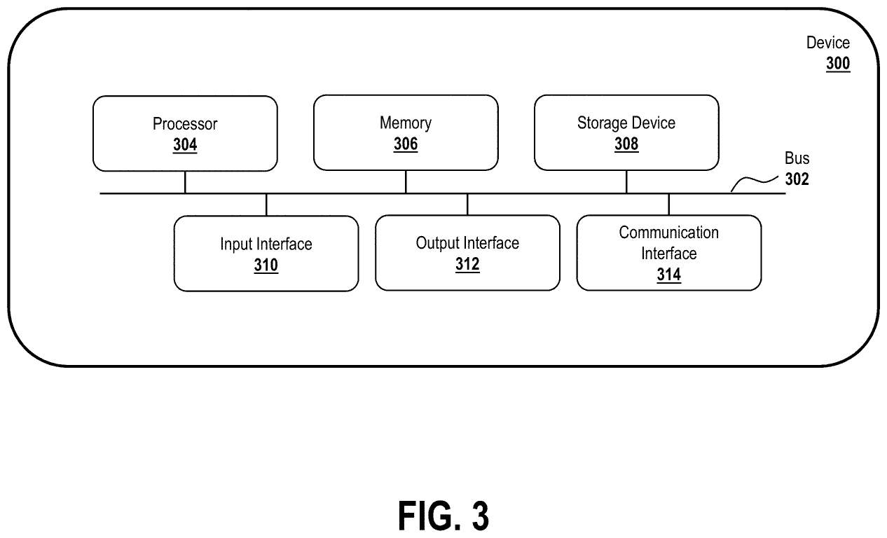

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data specifies at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

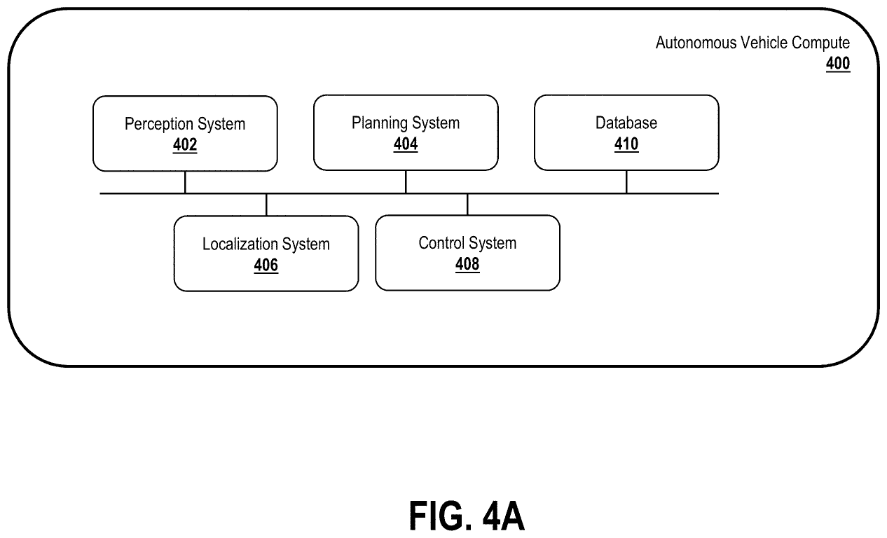

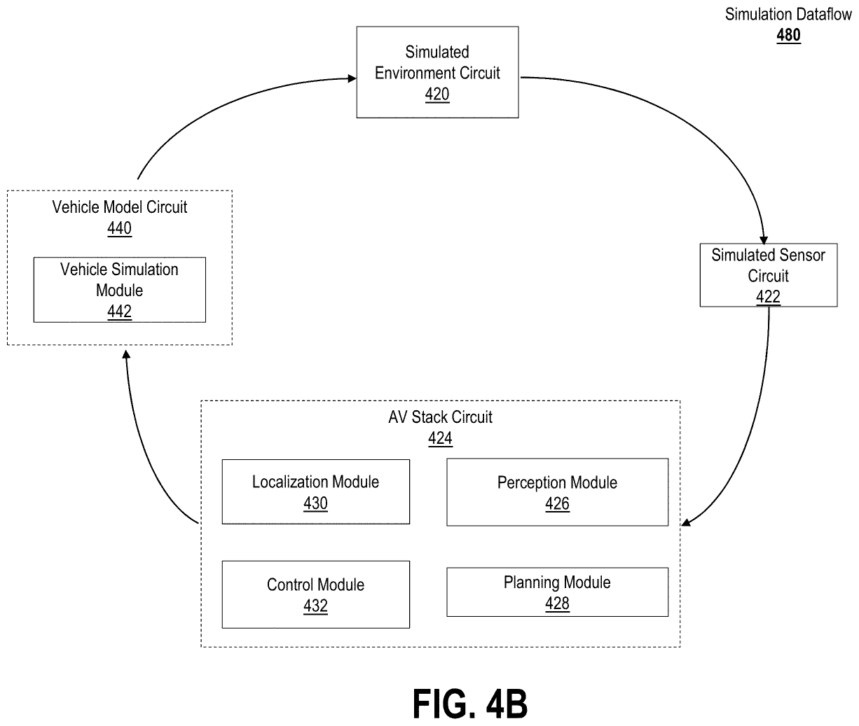

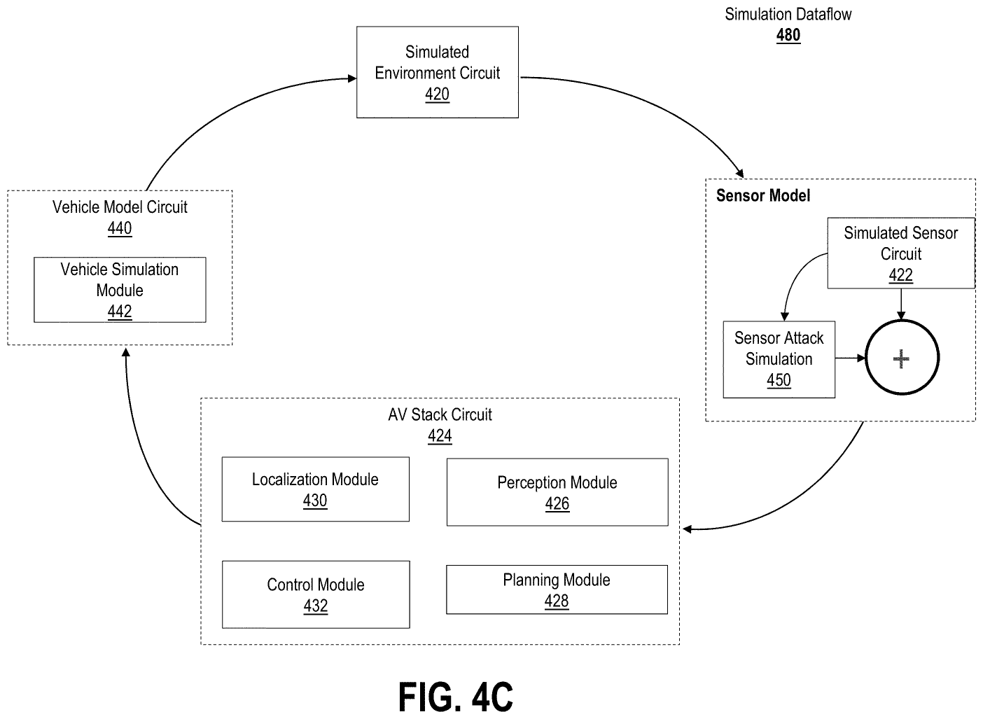

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

FIG. 4B shows an implementation of a simulation dataflow 480. As illustrated, the simulation dataflow 480 includes simulated environment circuit 420, simulated sensor circuit 422, AV stack circuit 424, and vehicle model circuit 440. The various circuits are communicatively coupled to one another. For example, the simulated environment circuit 420 is communicatively coupled to simulated sensor circuit 422, the simulated sensor circuit 422 is communicatively coupled to AV stack circuit 424, AV stack circuit 424 is communicatively coupled to vehicle model circuit 440, and vehicle model circuit 440 is communicatively coupled to simulated environment circuit 420. Data generated by one circuit is used as input for another circuit. For example, the data generated by the simulated environment circuit 420 is input for the simulated sensor circuit 422. In another example, the data generated by the vehicle model circuit 440 is input for the simulated environment circuit 420. Data flows around the loop and complete several iterations to determine the movement and responses of the simulated vehicle in the simulated environment circuit 420. The simulation dataflow 480 is configured to be a full system-level autonomous vehicle simulation that follows an iterating loop of data. Simulation dataflow 480 emulates the movement and response of a physical autonomous vehicle in a physical environment to increase the likelihood that the autonomous vehicle stack will perform well when provided with real data scenarios.

A simulated vehicle is placed into a simulated environment at simulated environment circuit 420. The simulated environment surrounding the simulated vehicle has various environmental conditions that are detectable and measurable by the simulated vehicle via simulated sensors. Examples of environmental conditions detectable by the simulated vehicle sensors include a proximate vehicle, an object in the roadway, an upcoming intersection, and an emergency siren. Examples of environmental conditions measurable by the simulated vehicle sensors include a distance to a proximate vehicle, a distance to an object in the roadway, a direction in which a pedestrian is walking, and the intensity and volume of the emergency siren. Additionally, the simulated environment circuit 420 generates simulated weather conditions, traffic conditions, roadway conditions, construction conditions, intersection conditions, pedestrians, and/or the like. In an embodiment, the vehicle model circuit 440 is configured to generate specific driving conditions and goal maneuvers for the simulated vehicle. These driving conditions and goal maneuvers determine the environment for the simulated vehicle and can be used to test the decisions of a physical autonomous vehicle in real-world driving scenarios. Simulated environment circuit 420 closely models real-world driving scenarios and, more specifically, real-world cyberattacks to increase the likelihood that the autonomous vehicle stack will perform well when challenged by real-world cyberattacks.

In an embodiment, the simulated environment circuit 420 is configured to emulate environment 100 and, more specifically, emulate area 108 in a simulation. In an embodiment, simulated environment circuit 420 emulates physical area 108 (e.g., a simulated geographic region) within which the simulated vehicle can navigate. In another embodiment example, simulated environment circuit 420 emulates at least one state (e.g., a country, a province, an individual state of a plurality of states included in a country, etc.), at least one portion of a state, at least one city, at least one portion of a city, and the like in the simulation dataflow 480. In another embodiment, simulated environment circuit 420 emulates a road such as a highway, an interstate highway, a parkway, a city street, etc. in the simulation dataflow 480. Additionally, or alternatively, in some examples, simulated environment circuit 420 emulates at least one unnamed road such as a driveway, a section of a parking lot, a section of a vacant and/or undeveloped lot, a dirt path, and the like in the simulation dataflow 480. In some embodiments, a simulated road includes at least one lane (e.g., a portion of the road that can be traversed by vehicles 102). In an example, a simulated road includes at least one lane associated with (e.g., identified based on) at least one lane marking.

With continued reference to FIG. 4B, simulated sensor circuit 422 emulates sensors at the simulated vehicle in the simulation dataflow 480. Simulated sensor circuit 422 is configured to collect measurable environmental data generated by the simulated environment circuit 420 and is configured to provide a simulated sensor dataset to the AV Stack. The simulated sensor dataset includes data from each of the simulated sensors in the same format or data type as the corresponding physical sensor. Additionally, the simulated sensor dataset is a dataset that appears to be generated by a physical set of sensors.

The simulated sensors emulated by simulated sensor circuit 422 include cameras, LiDAR sensors, radar sensors, microphones, IMUs, a GPS receiver, and real-time kinematics (RTK) receivers. In an embodiment, the simulated sensors are configured to emulate cameras 202a, LiDAR sensors 202b, radar sensors 202c, and microphones 202d as previously described. Additionally, the simulated sensor circuit 422 emulates other sensors including a wheel speed sensor, a wheel brake pressure sensor, a wheel torque sensor, an engine torque sensor, a steering angle sensor, and/or the like. The simulated sensors are configured to measure an environmental condition related to an environment of the autonomous vehicle. The simulated sensors are included in the autonomous vehicle sensor system. The simulated sensors are mounted to the simulated vehicle and are communicatively coupled to the simulated vehicle.

The simulated sensor circuit 422 generates a simulated sensor dataset. The simulated sensor dataset includes data from the various types of sensors at the vehicle. The simulated sensor dataset includes data from each of the simulated sensors in the same format or data type as the corresponding physical sensor. The simulated sensor dataset is formatted to correspond to the data type output by physical sensors. The simulated sensor dataset is representative of data received from physical sensors. The simulated sensor dataset includes measurements of environmental conditions. Examples of measurements of environmental conditions include a height of an object in a roadway, a distance between the vehicle and the median, and the distance to a stop sign. In an embodiment, the simulated sensor circuit 422 provides the simulated sensor dataset the AV stack circuit 424 in the same format or data type as corresponding physical sensors.

AV stack circuit 424 includes a perception module 426, planning module 428, localization module 430, control module 432, and a simulated database. In an embodiment, the AV stack circuit 424 simulates the perception module 426, planning module 428, localization module 430, and control module 432. Additionally, or alternatively, the AV stack circuit 424 can emulate perception system 402, planning system 404, localization system 406, control system 408, and database 410. In some embodiments, the AV stack circuit 424 includes perception module 426, planning module 428, localization module 430, control module 432, and a simulated database in one or more standalone systems that are located in the simulated vehicle. The AV stack circuit 424 is configured to make control decisions based on the simulated sensor dataset derived from the simulated sensor circuit 422 and the driving conditions and goal maneuvers for the simulated vehicle derived from vehicle model circuit 440.

In some embodiments, the perception module 426 receives the simulated sensor data associated with a simulated object (e.g., simulated sensor dataset that is used by perception module 426 to detect the simulated object) in a simulated environment and classifies the at least one simulated object. In some examples, the perception module 426 receives image data captured by the simulated camera, the images from which are associated with the simulated object. Perception module 426 classifies the simulated object based on one or more groupings of simulated objects (e.g., bicycles, vehicles, traffic signs, pedestrians, and/or the like). In some embodiments, perception module 426 transmits data associated with the classification of the simulated objects to planning module 428 based on perception module 426 classifying the simulated objects. The perception module 426 can be the same as, or similar to, perception system 402.

In some embodiments, planning module 428 receives data associated with a simulated destination and generates data associated with at least one simulated route along which a simulated vehicle can travel along toward a simulated destination. In some embodiments, planning module 428 periodically or continuously receives data from perception module 426 (e.g., dataset associated with the classification of simulated objects, described above) and planning module 428 updates the at least one simulated trajectory or generates at least one different simulated trajectory based on the data generated by perception module 426. In some embodiments, planning module 428 receives data associated with an updated position of the simulated vehicle from localization module 430 and planning module 428 updates the at least one simulated trajectory or generates at least one different simulated trajectory based on the data generated by localization module 430. The planning module 428 can be the same as, or similar to, planning system 404.

In some embodiments, localization module 430 receives data associated with (e.g., representing) a simulated location of the simulated vehicle in the simulated area. In some examples, localization module 430 receives simulated LiDAR data associated with at least one simulated point cloud generated by at least one simulated LiDAR sensor. In certain examples, localization module 430 receives data associated with at least one simulated point cloud from multiple simulated LiDAR sensors. Localization module 430 generates a combined simulated point cloud based on each of the simulated point clouds. In these examples, localization module 430 compares the at least one simulated point cloud or the combined simulated point cloud to two-dimensional (2D) and/or a three-dimensional (3D) map of the simulated area. Localization module 430 then determines the position of the simulated vehicle in the simulated area based on comparing the at least simulated one point cloud or the combined simulated point cloud to the map. In some embodiments, the simulated map includes a combined simulated point cloud of the simulated area generated prior to navigation of the simulated vehicle. In some embodiments, simulated maps include, without limitation, high-precision maps of the roadway geometric properties, maps describing road network connectivity properties, maps describing roadway simulated properties (such as traffic speed, traffic volume, the number of vehicular and cyclist traffic lanes, lane width, lane traffic directions, or lane marker types and locations, or combinations thereof), and maps describing the spatial locations of simulated road features such as crosswalks, traffic signs or other travel signals of various types. In some embodiments, the simulated map is generated in real-time based on the data received by the perception system. The localization module 430 can be the same as, or similar to, localization system 406.

With continued reference to FIG. 4B, in another example, localization module 430 receives simulated Global Navigation Satellite System (GNSS) data generated by a simulated global positioning system (GPS) receiver. In some examples, localization module 430 receives GNSS data associated with the location of the simulated vehicle in the simulated area and localization module 430 determines a latitude and longitude of the simulated vehicle in the simulated area. In such an example, localization module 430 determines the position of the simulated vehicle in the simulated area based on the latitude and longitude of the simulated vehicle. In some embodiments, localization module 430 generates simulated data associated with the position of the simulated vehicle. In some examples, localization module 430 generates data associated with the position of the simulated vehicle based on localization module 430 determining the position of the simulated vehicle.

In some embodiments, control module 432 receives data associated with at least one trajectory from planning module 428 and control module 432 controls the operation of the simulated vehicle. In some examples, control module 432 receives data associated with at least one simulated trajectory from planning module 428 and control module 432 controls operation of the simulated vehicle by generating and transmitting simulated control signals to cause a simulated powertrain control system, a simulated steering control system, and/or a simulated brake system to operate. In an example, where a simulated trajectory includes a left turn, control module 432 transmits a simulated control signal to cause the simulated steering control system to adjust a steering angle of the simulated vehicle, thereby causing the simulated vehicle to turn left. Additionally, or alternatively, control module 432 generates and transmits simulated control signals to cause other simulated devices (e.g., headlights, turn signal, door locks, windshield wipers, and/or the like) of the simulated vehicle to change states. The control module 432 can be the same as, or similar to, control system 408.

The vehicle model circuit 440 is configured to move the autonomous vehicle through the simulated environment based on the simulated control signals received from the AV stack circuit 424. The vehicle model circuit 440 is configured to receive simulated control signals generated by the AV stack circuit 424. The vehicle model circuit 440 includes a vehicle simulation module 442 configured to cause the vehicle to move through the simulated environment circuit 420. The vehicle model circuit 440 is configured to provide data to the simulated environment circuit 420 regarding the location and direction of the simulated vehicle within the simulated environment.

Referring now to FIG. 4C, illustrated is a diagram of an implementation of a simulation dataflow with a sensor attack simulation 450. Sensor attack simulation 450 is configured to simulate attacks on an autonomous vehicle to assess how the vehicle would respond to cyberattacks in real-world situations. The sensor attack simulation 450 is configured to modify the simulated sensor dataset created by the simulated sensor circuit 422 to imitate a cyberattack. In an embodiment, the sensor attack simulation 450 is included in the simulated sensor circuit 422. For example, the sensor attack simulation 450 is performed by the simulated sensor circuit 422 to simulate a cyberattack or a physical attack on the simulated sensors. Alternatively, the sensor attack simulation 450 is separated from the simulated sensor circuit 422 and the sensor attack simulation 450 is configured to receive the simulated sensor dataset from the simulated sensor circuit 422 to simulate a cyberattack or a physical attack on the simulated sensors.

Sensor attack simulation 450 is configured to perform a simulated attack on the simulated sensor dataset. The simulated attack includes modifying the simulated sensor dataset in a manner representative of an actual cyberattack. For example, the simulated attack includes a Denial-of-Service (DoS) attack in which no sensor data corresponding to a simulated sensor is included in the simulated sensor dataset. In another example, the simulated attack includes a modification of point clouds such that the simulated sensor dataset includes measurements of an object that did not exist in the simulated environment circuit 420.

Modifying the simulated sensor dataset resembles hacked or compromised software in a real-life scenario of a cyberattack. In a real-world cyberattack, the attacker typically gains control of the software running on a sensor or on another device on the network. To closely imitate a real-world cyberattack, the sensor attack simulation 450 deletes, adds, or modifies data from a simulated sensor dataset. For example, the sensor attack simulation 450 affects the camera sensor by preventing some of the video frames from the simulated environment circuit 420 from being received by the AV stack circuit 424. In another example, the sensor attack simulation 450 attacks a RADAR sensor by modifying radar returns in the simulated sensor dataset to include extra radar returns. The sensor attack simulation 450 impacts a single simulated sensor or a combination of sensors from simulated sensor circuit 422. For example, the sensor attack simulation 450 includes an emulation of a cyberattack on both the IMU and the GPS sensor. In another example, the sensor attack simulation 450 emulates a cyberattack of a first LiDAR, a second LiDAR sensor, a third LiDAR sensor, but not the fourth LiDAR sensor. The sensor attack simulation 450 outputs a modified dataset for testing the planned movement of the autonomous vehicle using the modified dataset. The modified dataset can be referred to as a weakened, attacked, or impaired dataset.

The sensor attack simulation 450 includes emulating cyberattacks on the simulated sensors at the simulated sensor circuit 422. The sensor attack simulation 450 emulates a Denial-of-Service cyberattack on at least one simulated camera by preventing some or all video frames from being included in the simulated sensor dataset. Other cyberattacks on the at least one simulated camera are emulated by modifying an image to add a shape (e.g., wall) that resembles a large object in the simulated vehicle's trajectory, removing a section of the frame data, adding pixel noise to attempt an adversarial machine learning attack, and inserting pixels that will inhibit processing at the perception module 426 or disrupt the planning module 428.

With continued reference to FIG. 4C, the sensor attack simulation 450 emulates a Denial-of-Service cyberattack on at least one simulated LiDAR from the simulated sensor circuit 422 by preventing some or all simulated point clouds from being included in the simulated sensor dataset. Other cyberattacks on the at least one simulated LiDAR are emulated by modifying a simulated point cloud to add a shape (e.g., wall) that resembles a large object in the simulated vehicle's trajectory, removing a section of the point cloud, and adding noise to the simulated point cloud data to attempt an adversarial machine learning attack.

The sensor attack simulation 450 performs a Denial-of-Service cyberattack on at least one simulated RADAR from the simulated sensor circuit 422 by preventing some or all radar returns from being included in the simulated sensor dataset. Other cyberattacks on the at least one simulated RADAR are emulated by modifying radar returns in the simulated sensor dataset to include extra radar returns. Additional cyberattacks are emulated by modifying RADAR returns to change the perceived distance to objects or the trajectories of objects and adding noise to radar data.

The sensor attack simulation 450 performs a Denial-of-Service cyberattack on at least one simulated IMU from the simulated sensor circuit 422 by preventing some or all IMU data from being included in the simulated sensor dataset. Other cyberattacks on the at least one simulated IMU are emulated by modifying IMU data and adding noise to the IMU data to affect the localization of the simulated vehicle.

The sensor attack simulation 450 performs a Denial-of-Service cyberattack on at least one simulated GPS receiver from the simulated sensor circuit 422 by preventing some or all GPS data from being included in the simulated sensor dataset. Other cyberattacks on the at least one simulated GPS are emulated by modifying GPS data and adding noise to the GPS data to affect the localization of the simulated vehicle. Additionally, cyberattacks are emulated by tampering with the simulated GPS data to modify the timing data used for system initialization.

The sensor attack simulation 450 performs a Denial-of-Service cyberattack on at least one simulated RTK receiver from the simulated sensor circuit 422 by preventing some or all RTK data from being included in the simulated sensor dataset. Other cyberattacks on the at least one simulated RTK receiver are emulated by modifying RTK data and adding noise to the RTK data to affect the localization of the simulated vehicle.

The sensor attack simulation 450 performs a Denial-of-Service cyberattack on at least one simulated microphone from the simulated sensor circuit 422 by preventing some or all simulated microphone data from being included in the simulated sensor dataset. Other cyberattacks on the at least one simulated microphone are emulated by modifying simulated sound data from the simulated environment circuit 420 to mimic sirens for emergency vehicle detection and adding noise to the microphone data to disguise the sound of sirens.

Sensor attack simulation 450 is configured to emulate a cyber-physical attack on the simulated sensor dataset. Sensor attack simulation 450 is configured to simulate cyber-physical attacks on an autonomous vehicle to assess how the vehicle would respond to cyber-physical attacks in real-world situations. Cyber-physical attacks include misrepresenting an environmental condition related to the environment of the autonomous vehicle. Cyber-physical attacks include misrepresenting an environmental condition related to the environment of the autonomous vehicle. The sensors measure the misrepresented environmental condition and the sensor data is sent to the AV stack where the vehicle can make movement decisions based on the misrepresented environment conditions. Cyber-physical attacks also include attempts to control sensor output via physical mechanisms. Unlike cyberattacks that compromise host software, cyber-physical attacks do not have access to the host software. In a cyber-physical attack, these misrepresented environment conditions are measured by sensors at the autonomous vehicles, which then causes damaging planned movements by the vehicle. An example of a cyber-physical attack that misrepresents an environmental condition includes blinding a camera with a laser and emitting extraneous sounds in an acoustic attack. Other examples of cyber-physical attacks include projecting a lens flare onto a camera and jamming the IMU or the GPS receiver. These and other cyber-physical attacks cause the sensor dataset to include measurements of an object that did not exist in the simulated environment circuit 420.

With continued reference to FIG. 4C, the sensor attack simulation 450 is configured to modify the simulated sensor dataset created by the simulated sensor circuit 422 to emulate cyber-physical attacks. The sensor attack simulation 450 is configured to modify the simulation sensor dataset such that it appears the simulated sensors gathered data relating to falsified environmental conditions. The sensor attack simulation 450 is configured to modify the simulation sensor dataset to closely resemble real-life scenarios of cyber-physical attacks. To closely imitate cyber-physical attacks, the sensor attack simulation 450 deletes, adds, or modifies data from a simulated sensor. For example, the sensor attack simulation 450 emulates damage caused by a high-power laser on the camera sensor by adding noise to the video frames from the simulated environment circuit 420. In another example, the sensor attack simulation 450 emulates a spoofing attack on a RADAR sensor by adding extra radar returns. The cyber-physical attack emulated by the sensor attack simulation 450 impacts a single simulated sensor or a combination of sensors. For example, the sensor attack simulation 450 includes cyber-physical attack simulations on both the IMU and the GPS sensor. In another example, the sensor attack simulation 450 includes a cyber-physical attack simulation of a first LiDAR, a second LiDAR sensor, a third LiDAR sensor, but not the fourth LiDAR sensor. The sensor attack simulation can perform both software cyberattacks and cyber-physical attacks simultaneously.

The sensor attack simulation 450 includes cyber-physical attacks on the simulated sensors at the simulated sensor circuit 422. The sensor attack simulation 450 performs a cyber-physical attack on at least one simulated camera by emulating the simulated camera being blinded remotely with a laser by preventing some or all video frames from being included in the simulated sensor dataset. Other cyber-physical attacks, such as damage caused by a high-power laser on the camera, are emulated by modifying an image dataset to add noises and adding images projected into the simulated road to the dataset. The sensor attack simulation 450 emulates additional cyber-physical attacks by adding images to the dataset to emulate a lens flare, adding images to the simulated camera dataset to emulate adversarial patches in the environment, and adding noise to the simulated camera dataset to emulate an acoustic attack on the image stabilization of the emulated camera. These cyber-physical attacks inhibit processing at the perception module 426 or disrupt the planning module 428.

The sensor attack simulation 450 performs a cyber-physical attack on at least one simulated LiDAR by emulating a laser jamming a region of the LiDAR point cloud, which includes preventing some or all simulated point clouds from being included in the simulated sensor dataset. Other cyber-physical attacks on the at least one simulated LiDAR include emulating a laser spoofing a point cloud data by modifying a simulated point cloud in the simulated LiDAR sensor dataset.

With continued reference to FIG. 4C, the sensor attack simulation 450 performs a cyber-physical attack on at least one simulated RADAR by emulating a remote jamming of radar returns, which includes sensor attack simulation 450 preventing some or all simulated radar returns from being included in the simulated sensor dataset. Other cyber-physical attacks on the at least one simulated RADAR include emulating a remote spoofing of radar returns by adding a radar return to the simulated RADAR sensor dataset.

The sensor attack simulation 450 performs a cyber-physical attack on at least one simulated IMU by emulating an acoustic attack on resonant IMU structures. Emulating the acoustic attack includes removing simulated IMU data, distorting simulated IMU data by adding noise to simulated IMU data, or by adding additional IMU data to make the vehicle location unclear. Removing simulated IMU data includes preventing the simulated IMU dataset from being received at the AV stack circuit 424.

The sensor attack simulation 450 performs a cyber-physical attack on at least one simulated GPS receiver by emulating a remote jamming of the simulated GPS receiver, which includes sensor attack simulation 450 preventing some or all GPS datasets from being included in the simulated sensor dataset. Other cyber-physical attacks on the at least one simulated GPS include emulating a remote spoofing of GPS signals by adding a GPS signal to the simulated GPS sensor dataset.

The sensor attack simulation 450 performs a cyber-physical attack on at least one simulated RTK from the simulated sensor circuit 422 by emulating jamming of the cellular network. Emulating the jamming of the cellular network includes removing simulated RTK data, distorting simulated RTK data by adding noise to simulated RTK data, or by adding additional RTK data to make the vehicle location unclear. Removing simulated RTK data includes preventing the simulated RTK dataset from being received at the AV stack circuit 424.

The sensor attack simulation 450 performs a cyber-physical attack on at least one simulated microphone from the simulated sensor circuit 422 by emulating sirens with no emergency vehicle nearby, which includes adding siren audio datasets to the simulated sensor dataset. Other cyber-physical attacks on the at least one simulated microphone sensor includes emulating an intentional electromagnetic interference, an ultrasound interference, or a laser interference to generate acoustic signals by adding static audio datasets to the simulated dataset.

The sensor attack simulation 450 can perform additional simulated attacks on the dataset in which the dataset is further modified to imitate a cyberattack or imitate a cyber-physical attack of a different nature or a different sensor. The additional simulated attacks are performed on a combination of sensors using a variety of cyberattacks and/or cyber-physical attacks. In an embodiment, a simulated attack is configured to attack a first subset and a second subset of the simulated sensor dataset, the first subset and the second subset corresponding to a first sensor and a second sensor of the plurality of sensors, the first sensor being a different type than the second sensor. In another embodiment, the simulated attack of the first subset of the simulated sensor dataset is distinct from the second subset of the simulated sensor dataset.

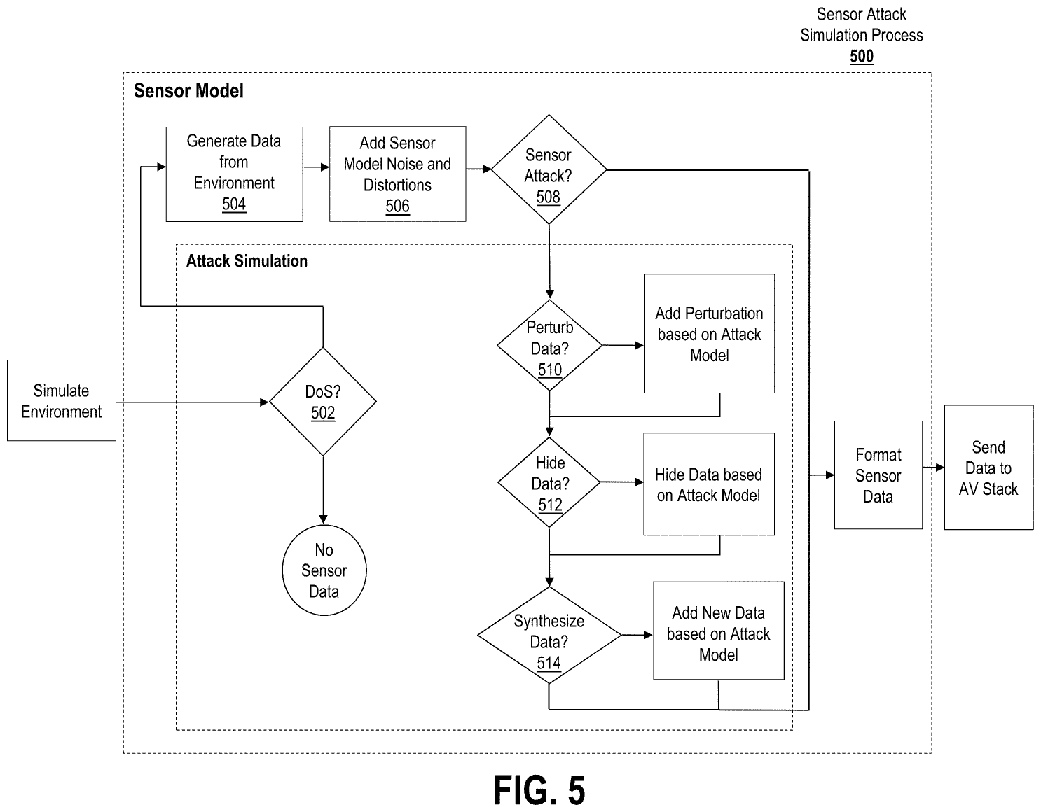

Referring now to FIG. 5, illustrated is a diagram of a sensor attack simulation process 500 for a sensor attack simulation. The simulated sensor circuit 422 carries out the instructions in the sensor attack simulation process 500. The sensor attack simulation process 500 determines how the simulated sensor dataset is modified to emulate a cyberattack or a cyber-physical attack. Additionally, the sensor attack simulation process 500 can determine the type of cyberattack or the cyber-physical attack to be emulated on the simulated sensor dataset. Further, the sensor attack simulation process 500 includes modifying at least a subset of data corresponding to at least one sensor from the simulated sensor dataset and sensor attack simulation process 500 is configured to modify a combination of subsets of data from the simulated sensor dataset to emulate an attack on a combination of sensors. The sensor attack simulation 450 is configured to receive the data from the simulated environment circuit 420.

In an embodiment, the sensor attack simulation process 500 provides an instruction to simulated sensor circuit 422. The instruction is configured to perform the simulated attack of the dataset. The simulated sensor circuit 422 is configured to format the second dataset for presentation to the simulated control circuit (e.g., AV stack circuit 424) that is configured to plan movement of the simulated autonomous vehicle. The instruction is configured to perform at least one of distorting measurement data from the dataset, removing the measurement data from the dataset, synthesizing the measurement data from the dataset, and imitating a Denial-of-Service attack by bypassing measurement data from the dataset. The instruction is configured to emulate a cyberattack or a cyber-physical attack on the simulated sensor dataset. The sensor attack simulation process 500 outputs a modified dataset for testing planned movement of the autonomous vehicle using the modified dataset. The modified dataset can be referred to as a weakened, attacked, or impaired dataset.

At 502, the sensor attack simulation process 500 determines whether a Denial-of-Service attack is to occur on the simulated sensor dataset. If a Denial-of-Service attack is to be performed, no sensor data is generated by the simulated sensor circuit 422 for at least one corresponding sensor. For example, the sensor attack simulation process 500 performs a cyberattack on at least one simulated IMU from the simulated sensor circuit 422 by performing a Denial-of-Service attack. The Denial-of-Service attack includes preventing some or all IMU data from being included in the simulated sensor dataset and, consequently, received at the AV stack circuit 424. The sensor attack simulation 450 removes the subset of data corresponding to the simulated IMU data from the simulated sensor dataset. Additionally, or alternatively, the sensor attack simulation 450 prevents sensor data from being created and sent to the AV stack circuit 424. In an embodiment, an instruction configured to emulate the Denial-of-Service attack includes prohibiting sensor data from at least one sensor of the plurality of sensors from being included in the second dataset. The Denial-of-Service attack can be tested with various sensors and various combinations of sensors to determine how the vehicle will respond.

At 504, data from the simulated environment circuit 420 is collected. The simulated sensor circuit 422 gathers environmental data proximate to the simulated vehicle placed in the environment. The environmental data includes environmental conditions measurable by the simulated sensors. Examples of environmental conditions measurable by the simulated vehicle include a proximate vehicle, an object in the roadway, an upcoming intersection, and an emergency siren. Additionally, the sensors at the simulated sensor circuit 422 generate simulated weather conditions, traffic conditions, roadway conditions, construction conditions, intersection conditions, persons, and or the like. The simulated sensors are configured to gather geographical data related to the position of the simulated vehicle.

At 506, noise and distortions are added to the simulated sensor data to imitate actual data gathered in the physical world. For example, image data from the simulated camera is slightly distorted to emulate particles of dust on the camera lens.

At 508, whether a sensor attack is to be performed on the simulated sensor dataset is determined. If no attack is to occur, that the simulated sensor circuit 422 formats the simulated sensor dataset and sends the simulated sensor dataset to AV stack circuit 424. If not, at least one of perturbing data, hiding data, and synthesizing data are performed on the simulated sensor dataset. Any combination of perturbing data, hiding data, and synthesizing data can be performed on the simulated sensor dataset. The simulated sensor data is modified in a way that would be difficult to detect for the AV stack circuit 424. The data modification occurs in a manner that best models the potential cyberattacks and cyber-physical attacks against the autonomous vehicle. Data is modified according to the type of attack and the type of sensor that is being attacked.

At 510, whether to perturb data in the simulated sensor dataset is determined. Data to be perturbed corresponds to a simulated sensor that can be included as a subset of data in the simulated sensor dataset. Perturbing the data includes adding random noise to the measurement data from the simulated sensor dataset. Perturbing the data includes adding a patterned noise to the measurement data from the simulated sensor dataset. For example, noise is added to the radar dataset in the simulated sensor dataset to emulate a cyber-physical attack on the RADAR sensor. In another example, noise is added to GPS data to affect the localization of the simulated vehicle. In an implementation, the added noise patterns an adversarial machine learning attack. In an embodiment, perturbing the dataset includes an instruction to add random noise or a patterned noise to the measurement data from the simulated sensor dataset.

At 512, whether to hide data in the simulated sensor dataset is determined. The data corresponds to a subset of data from the simulated sensor subset corresponding to a simulated sensor. Hiding the data includes cutting out data from a set of data from the subset. For example, LiDAR returns in a subrange of azimuthal angles of a LiDAR point cloud may be removed from LIDAR data in the simulated sensor dataset. In another example, information in an image is removed by setting a group of pixels to max brightness to simulate a laser blinding.

At 514, whether to synthesize data in the simulated sensor dataset is determined. The data corresponds to a subset of data from the simulated sensor subset corresponding to a simulated sensor. Synthesizing the data includes adding new values to the data to confuse the AV stack circuit 424. For example, data representative of additional radar returns is added to the simulated sensor dataset to confuse the AV stack. Additional data packets or adding data values to emulated specific shapes or values that the packets that are sent to the AV Stack. In another example, data points are added to a simulated point cloud to add a shape (e.g., wall) that resembles a large object with which the vehicle is projected to collide. In an embodiment, the instruction configured to synthesize measurement data from the dataset includes adding new values to the measurement data from the dataset for confusing the simulated control circuit at the autonomous vehicle.

The perturbed data, the hidden data, or the synthesized data is formatted by the simulated sensor circuit 422 to generate a second dataset that is sent to the AV stack circuit 424.

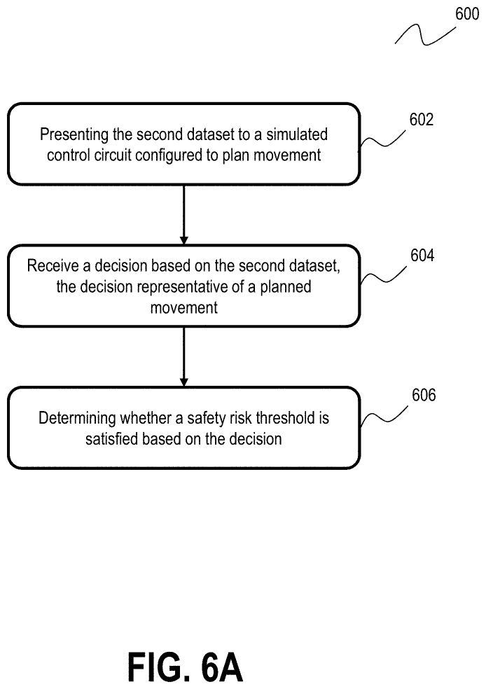

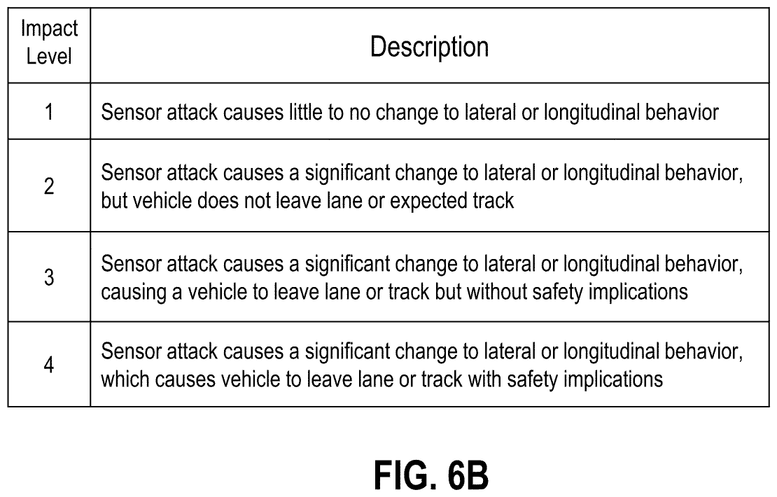

Referring now to FIG. 6A, illustrated is a safety risk threshold process 600 for determining whether a safety risk threshold is satisfied based on a decision of a planned movement of the autonomous vehicle. In some embodiments, one or more of the steps described with respect to safety risk threshold process 600 are performed (e.g., completely, partially, and/or the like) by simulation sensor circuit 422. Additionally, or alternatively, in some embodiments, one or more steps described with respect to safety risk threshold process 600 are performed (e.g., completely, partially, and/or the like) by another device or group of devices separate from or including simulation sensor circuit 422, such as AV stack circuit 424 or vehicle model circuit 440.

After completing a simulation of the cyberattack or the cyber-physical attack, the results of the simulation are stored. The safety risk threshold process 600 determines whether the safety risk threshold is exceeded based on the results of the simulation. In an embodiment, the safety risk threshold process 600 determines whether at least one safety risk threshold is exceeded and determines an impact level.

At 602, the second dataset is presented to a simulated control circuit. The second dataset includes the attacked simulated sensor dataset that is weakened or compromised based on the cyberattack of the cyber-physical attack. For example, the second dataset includes additional radar returns that are meant to confuse the simulated control circuit regarding the location of an approaching object. The second dataset is generated by the simulated sensor circuit 422 and is used for testing planned movements of the autonomous vehicle. For example, the second dataset includes LiDAR, RADAR, and camera readings to assist the vehicle to a safe stop before arriving to an object in the roadway. The simulated control circuit includes the AV stack circuit 424. The AV stack circuit controls the prediction, planning, and control of the autonomous vehicle based on the second dataset. The simulated control circuit is configured to plan movement of the autonomous vehicle.

At 604, a decision based on the second dataset is received from the simulated control circuit. The decision is representative of a planned movement of the autonomous vehicle associated using the second dataset. For example, the second dataset includes data representative of emergency sirens resulting from a cyber-physical attack on the microphone. The data representative of the emergency sirens is received by the simulated control circuit. The simulated control circuit, based on the emergency sirens, makes a decision to plan movement involving arriving at a stop or to pulling over to the side of the road.

At 606, whether a safety risk threshold is satisfied based on the decision is determined. The safety risk threshold is indicative of whether the decision from the simulated control circuit endangers the autonomous vehicle. Examples of safety risk thresholds vary according to the intensity of the danger that is tolerable. For example, a low-tolerance safety threshold includes determining the sensor attack causes a minor change to immediate or long-term safety. In another example, a high-tolerance safety threshold includes determining the sensor attack causes a significant change to immediate safety and that the vehicle can leave the lane with safety implications.

In some embodiments, determining whether the safety risk threshold is satisfied includes determining a baseline decision. The baseline decision is based on the autonomous vehicle response without a cyberattack or a cyber-physical attack. The baseline decision is based on the simulated sensor dataset. The simulated sensor dataset is data representative of the data gathered by the plurality of sensors at the autonomous vehicle without a cyberattack or a cyber-physical attack. The baseline decision is made by the simulated control circuit and is representative of the planned movement of the autonomous vehicle associated with the dataset. For example, the simulated control circuit determines that the baseline decision for an object in the road is to change lanes before arriving at the object if no proximate vehicles are present. The baseline decision is associated with a baseline safety risk. The baseline safety risk is determined based on the baseline decision. The baseline safety risk is indicative of a danger to the autonomous vehicle without a cyberattack or a cyber-physical attack. For example, the baseline safety risk is no immediate or long-term safety implications by an object 200 feet ahead of the autonomous vehicle.

Similar to the baseline safety risk, a safety risk based on the decision is determined. The safety risk is associated with the decision based on the second dataset and is indicative of danger to the autonomous vehicle based on the decision. As discussed in a previous example, the simulated control circuit, in response to the spoofed emergency sirens, makes a decision to plan movement involving arriving at a stop or pulling over to the side of the road. The safety risk of pulling over to the side of the road is low as there is no immediate or long-term safety implications by the spoofed emergency sirens. A high safety risk exists if the decision is to stop the autonomous vehicle in the lane as there are immediate safety implications caused by the spoofed emergency sirens.

A difference between the safety risk and the baseline safety risk is calculated. For example, the AV stack circuit 424 calculates that there is no difference between the baseline safety risk of all LiDAR sensors being operational and one redundant LiDAR sensor nonoperational due to a cyberattack. In another example, the AV stack circuit 424 calculates a significant difference between the baseline safety risk of all LiDAR sensors being operational and two LiDAR sensors being nonoperational due to a cyberattack.

Whether the difference satisfies the safety risk threshold is determined. The safety risk threshold is indicative of whether the decision from the simulated control circuit endangers the autonomous vehicle. Examples of safety risk thresholds vary according to the intensity of the danger that is tolerable. For example, a low-tolerance safety threshold includes determining the sensor attack causes a minor change to immediate or long-term safety. In another example, a high-tolerance safety risk threshold includes determining the sensor attack causes a significant change to immediate safety and that the vehicle can leave the lane with safety implications.

Referring now to FIG. 6B, illustrated is a table of safety risk thresholds that correspond to an impact level on the autonomous vehicle. At impact level 1, a low-tolerance safety risk threshold corresponds to determining the sensor attack causes no change or a minor change to immediate or long-term vehicle safety and no change to lateral or longitudinal vehicle behavior. At impact level 2, a medium-tolerance safety risk threshold corresponds to determining the sensor attack causes significant change to vehicle behavior, including lateral and/or longitudinal vehicle behavior, but that the vehicle does not leave the lane or track. At impact level 3, a medium-high tolerance safety risk threshold corresponds to determining the sensor attack causes significant change to vehicle behavior, including lateral and/or longitudinal vehicle behavior, and that the vehicle leaves the lane or track but without safety implications. At impact level 4, a high tolerance safety risk threshold corresponds to determining the sensor attack causes significant change to vehicle behavior, including lateral and/or longitudinal vehicle behavior, and that the vehicle leaves the lane or track with safety implications.

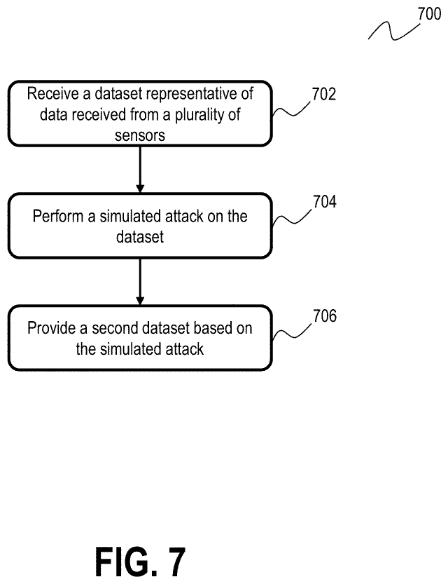

Referring now to FIG. 7, illustrated is a flowchart of a process 700 for a sensor attack simulation system. In some embodiments, one or more of the steps described with respect to process 700 are performed (e.g., completely, partially, and/or the like) by simulation sensor circuit 422. Additionally, or alternatively, in some embodiments, one or more steps described with respect to process 700 are performed (e.g., completely, partially, and/or the like) by another device or group of devices separate from or including simulation sensor circuit 422, such as AV stack circuit 424.

At 702, a dataset is received that is representative of data received from a plurality of sensors at an autonomous vehicle sensor system in which the plurality of sensors measures an environmental condition related to an environment of an autonomous vehicle. For example, the dataset includes measurements captured by LiDAR sensors, RADAR sensors, cameras, IMUs, GPS units, microphones, and the like.

At 704, a simulated attack on the dataset is performed. The simulated attack comprising at least one of modifying the dataset to imitate a cyberattack and modifying the dataset to imitate a cyber-physical attack in which the cyber-physical attack misrepresents the environmental condition related to the environment of the autonomous vehicle to be measured by the plurality of sensors at the autonomous vehicle sensor system. For example, a Denial-of-Service cyberattack is performed on at least one simulated LiDAR from the simulated sensor circuit 422 by preventing some or all simulated point clouds from being included in the simulated sensor dataset.

At 706, a second dataset is provided based on the simulated attack on the dataset. The second dataset is used for testing planned movements of the autonomous vehicle. For example, the sensor attack simulation 450 generates a dataset with an added shape to a simulated point cloud to resemble a large object in the simulated vehicle's trajectory.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
receiving, by one or more processors, a dataset representative of data received from a plurality of sensors at an autonomous vehicle sensor system in which the plurality of sensors measure an environmental condition related to an environment of an autonomous vehicle;
performing, by the one or more processors, a simulated attack on the dataset, the simulated attack comprising at least one of modifying the dataset to imitate a cyberattack and modifying the dataset to imitate a cyber-physical attack in which the cyber-physical attack misrepresents the environmental condition related to the environment of the autonomous vehicle to be measured by the plurality of sensors at the autonomous vehicle sensor system; and
providing, by the one or more processors, a second dataset based on the simulated attack on the dataset for testing planned movements of the autonomous vehicle using the second dataset.

2. The method of claim 1, further comprising:
performing, by the one or more processors, an additional simulated attack on the dataset, the additional simulated attack comprising at least one of modifying the dataset to imitate the cyberattack and modifying the dataset to imitate the cyber-physical attack in which the cyber-physical attack misrepresents the environmental condition related to the environment of the autonomous vehicle to be measured by the plurality of sensors at the autonomous vehicle sensor system; and
providing, by the one or more processors, the second dataset based on the simulated attack and the additional simulated attack for the testing planned movements of the autonomous vehicle using the second dataset,
wherein the simulated attack is different than the additional simulated attack.

3. The method of claim 1, further comprising:
presenting, by the one or more processors, the second dataset to a simulated control circuit configured to plan movement of the autonomous vehicle;
receiving, from the simulated control circuit and by the one or more processors, a decision based on the second dataset, the decision representative of a planned movement of the autonomous vehicle associated using the second dataset; and
determining, by the one or more processors, whether a safety risk threshold is satisfied based on the decision, the safety risk threshold being indicative of whether the decision from the simulated control circuit endangers the autonomous vehicle.

4. The method of claim 3, wherein determining whether the safety risk threshold is satisfied comprises:
receiving, from the simulated control circuit and by the one or more processors, a baseline decision based on the dataset, the baseline decision representative of the planned movement of the autonomous vehicle associated with the dataset;
determining, by the one or more processors, a baseline safety risk based on the baseline decision, the baseline safety risk indicative of a danger to the autonomous vehicle;
determining, by the one or more processors, a safety risk based on the decision, the safety risk indicative of another danger to the autonomous vehicle;
calculating, by the one or more processors, a difference between the safety risk and the baseline safety risk; and
determining, by the one or more processors, whether the difference satisfies the safety risk threshold, the safety risk threshold being indicative of whether the decision from the simulated control circuit endangers the autonomous vehicle.

5. The method of claim 1, further comprising:
providing, by the one or more processors, an instruction to a simulated sensor circuit, the instruction configured to perform the simulated attack of the dataset, the simulated sensor circuit configured to format the second dataset for presentation to a simulated control circuit configured to plan movement of the autonomous vehicle.

6. The method of claim 5, wherein the instruction is configured to perform at least one of distorting measurement data from the dataset, removing the measurement data from the dataset, synthesizing the measurement data from the dataset, and imitating a Denial-of-Service by bypassing measurement data from the dataset, and wherein the instruction is configured to imitate an effect of at least one of the cyberattack and the cyber-physical attack on the dataset.

7. The method of claim 6, wherein the instruction configured to imitate the Denial-of-Service includes prohibiting sensor data from at least one sensor of the plurality of sensors from being included in the second dataset.

8. The method of claim 6, wherein the instruction configured to distort the measurement data from the dataset includes adding at least one of random noise to the measurement data from the dataset and a patterned noise to the measurement data from the dataset.

9. The method of claim 6, wherein the instruction configured to synthesize the measurement data from the dataset includes adding new values to the measurement data from the dataset for confusing the simulated control circuit at the autonomous vehicle.

10. The method of claim 1, wherein receiving the dataset representative of data received from the plurality of sensors at the autonomous vehicle sensor system comprises:
receiving the dataset from an autonomous vehicle simulation including an environmental simulation.

11. A system comprising:
at least one processor, and
at least one non-transitory storage media storing instructions that, when executed by the at least one processor, cause the at least one processor to perform operations comprising:
receive a dataset representative of data received from a plurality of sensors at an autonomous vehicle sensor system in which the plurality of sensors measure an environmental condition related to an environment of an autonomous vehicle;
perform a simulated attack of the dataset, the simulated attack being configured to perform at least one of modifying the dataset and misrepresenting the environmental condition related to the environment of the autonomous vehicle to be measured by the plurality of sensors at the autonomous vehicle sensor system; and
provide a second dataset based on the simulated attack on the dataset for testing planned movements of the autonomous vehicle using the second dataset.

12. The system of claim 11, wherein the operations further comprise:
perform an additional simulated attack on the dataset, the additional simulated attack comprising at least one of modifying the dataset and misrepresenting the environmental condition related to the environment of the autonomous vehicle to be measured by the plurality of sensors at the autonomous vehicle sensor system; and
provide the second dataset based on the simulated attack and the additional simulated attack for the testing planned movements of the autonomous vehicle using the second dataset,
wherein the simulated attack is different than the additional simulated attack.

13. The system of claim 11, wherein the operations further comprise:
present the second dataset to a simulated control circuit configured to plan movement of the autonomous vehicle;
receive, from the simulated control circuit, a decision based on the second dataset, the decision representative of a planned movement of the autonomous vehicle associated using the second dataset; and
determine whether a safety risk threshold is satisfied based on the decision, the safety risk threshold being indicative of whether the decision from the simulated control circuit endangers the autonomous vehicle.

14. The system of claim 13, wherein determining whether the safety risk threshold is satisfied comprises:
receive, from the simulated control circuit, a baseline decision based on the dataset, the baseline decision representative of the planned movement of the autonomous vehicle associated with the dataset;
determine a baseline safety risk based on the baseline decision, the baseline safety risk indicative of a danger to the autonomous vehicle;
determine a safety risk based on the decision, the safety risk indicative of another danger to the autonomous vehicle;
calculate a difference between the safety risk and the baseline safety risk; and
determine whether the difference satisfies the safety risk threshold, the safety risk threshold being indicative of whether the decision from the simulated control circuit endangers the autonomous vehicle.

15. The system of claim 11, wherein the operations further comprise:
provide an instruction to a simulated sensor circuit, the instruction configured to perform the simulated attack of the dataset, the simulated sensor circuit configured to format the second dataset for presentation to a simulated control circuit configured to plan movement of the autonomous vehicle.

16. The system of claim 15, wherein the instruction is configured to perform at least one of distorting measurement data from the dataset, removing the measurement data from the dataset, synthesizing the measurement data from the dataset, and perform a Denial-of-Service of the measurement data from the dataset, and wherein the instruction is configured to emulate an impairment on the autonomous vehicle.

17. The system of claim 16, wherein the instruction configured to perform the Denial-of-Service includes prohibiting sensor data from at least one sensor of the plurality of sensors from being included in the second dataset.

18. The system of claim 16, wherein the instruction configured to distort the measurement data from the dataset includes adding at least one of random noise to the measurement data from the dataset and a patterned noise to the measurement data from the dataset.

19. The system of claim 16, wherein the instruction configured to synthesize the measurement data from the dataset includes adding new values to the measurement data from the dataset for confusing the simulated control circuit at the autonomous vehicle.

20. A non-transitory computer-readable storage medium comprising at least one program for execution by one or more processors of a first device, the at least one program including instructions which, when executed by the one or more processors, cause the first device to perform:
receiving, by the one or more processors, a dataset representative of data received from a plurality of sensors at an autonomous vehicle sensor system in which the plurality of sensors measure an environmental condition related to an environment of an autonomous vehicle;
performing, by the one or more processors, a simulated attack on the dataset, the simulated attack comprising at least one of modifying the dataset to imitate a cyberattack and modifying the dataset to imitate a cyber-physical attack in which the cyber-physical attack misrepresents the environmental condition related to the environment of the autonomous vehicle to be measured by the plurality of sensors at the autonomous vehicle sensor system; and
providing, by the one or more processors, a second dataset based on the simulated attack on the dataset for testing planned movements of the autonomous vehicle using the second dataset.
